(19) United States
(12) Patent Application Publication
(10) Pub. No.: US 2018/0041564 A1
(43) Pub. Date: Feb. 8, 2018

(54) ELECTRONIC BLACKBOARD SYSTEM

(71) Applicant: Taro OKUYAMA, Tokyo (JP)

(72) Inventor: Taro OKUYAMA, Tokyo (JP)

(21) Appl. No.: 15/786,635

(22) Filed: Oct. 18, 2017

Related U.S. Application Data
(63) Continuation of application No. PCT/JP2016/002243, filed on Apr. 28, 2016.

(30) Foreign Application Priority Data
May 8, 2015 (JP) 2015-095597
Apr. 12, 2016 (JP) 2016-079799

(51) Int. Cl. H04L 29/08; H04N 21/4782; H04N 21/414; H04N 21/4728; G06T 11/80; H04N 21/2343

(52) U.S. Cl. CPC H04L 67/02; G06T 11/80; H04N 21/234309; H04N 21/234363; H04N 21/41407; H04N 21/4728; H04N 21/4782

(57) ABSTRACT

An electronic blackboard system includes an electronic blackboard, and at least one communication terminal connected to the electronic blackboard via a communication network. The electronic blackboard includes: an image generation unit configured to superimpose layers to be displayed in the electric black board, to generate a display image, and generate a distribution image that does not include an operation panel display layer for displaying an operation panel; and a distribution module configured to transmit the distribution image to the at least one communication terminal. Each of the at least one communication terminal includes: a communication control unit configured to receive the distribution image transmitted from the electronic blackboard; and an image display unit configured to display the distribution image that is received by the communication control unit and in which the operation panel display layer is excluded.

### CROSS-REFERENCE TO RELATED APPLICATIONS

The present application is a continuation application of International Application No. PCT/JP2016/002243, filed Apr. 28, 2016, which claims priority to Japanese Patent Application No. 2015-095597, filed May 8, 2015, and Japanese Patent Application No. 2016-079799, filed Apr. 12, 2016. The contents of these applications are incorporated herein by reference in their entirety.

### BACKGROUND OF THE INVENTION

### 1. Field of the Invention

The present invention relates to an electronic blackboard system.

### 2. Description of the Related Art

In recent years, electronic blackboards such as electronic whiteboards (interactive whiteboards: IWBs) have been widely used as display apparatuses. Such an electronic blackboard has a configuration combining an image display device that includes a flat panel such as a liquid crystal panel, a coordinate detection device such as a touch panel that detects coordinates of a position on a display surface of the image display device where an object used for input such as an input pen or a finger touches, and a control device that causes an image including various images, text, numbers, and figures written on the display surface of the image display device to be displayed based on coordinate data output from the coordinate detection device. With this electronic blackboard, conference material or any other material can be enlarged and displayed, and an input pen or a finger can be used to write on the display surface.

As display systems, electronic blackboard systems that each connect an electronic blackboard as described above and communication terminals (client terminals) such as personal computers (PCs) and tablet computers via a network such as an in-house LAN, exist. The electronic blackboard system can compress an image displayed on or a written video drawn on the electronic blackboard and distribute the compressed image or written video to a communication terminal, so that the image on the electronic blackboard can be viewed from the communication terminal.

Japanese Laid-open Patent Publication No. 2014-199650 describes a technique to transmit image data of content generated by an electronic blackboard to a communication terminal. The technique includes cutting out part of the image data, converting the cut-out image data into transmission data, and transmitting the converted data to the communication terminal.

The typical electronic blackboard system known to the inventor, however, basically distributes all images generated by the electronic blackboard, and therefore an image including an area that should not be distributed is distributed as it is to the communication terminal. The area of the image undesirable for distribution can be trimmed out before the image is distributed; however, if the area to exclude is transparent, an image displayed under the trimmed image is missing from the distributed image. Also, the area to exclude may dynamically change depending on the status of the display apparatus, and in this case, the area is difficult to specify.

The technique described in Japanese Laid-open Patent Publication No. 2014-199650 that cuts out part of image data does not solve the problems of missing of a generated image and the difficulty in specifying a variable area to exclude.

### SUMMARY OF THE INVENTION

According to one aspect of the present invention, an electronic blackboard system includes an electronic blackboard, and at least one communication terminal connected to the electronic blackboard via a communication network. The electronic blackboard includes an image generation unit and a distribution module. The image generation unit is configured to superimpose layers to be displayed in the electric black board, to generate a display imag, and generate a distribution image that does not include an operation panel display layer for displaying an operation panel. The distribution module is configured to transmit the distribution image to the at least one communication terminal. Each of the at least one communication terminal includes a communication control unit and an image display unit. The communication control unit is configured to receive the distribution image transmitted from the electronic blackboard. The image display unit is configured to display the distribution image that is received by the communication control unit and in which the operation panel display layer is excluded.

### BRIEF DESCRIPTION OF THE DRAWINGS

FIG. 1 is a block diagram illustrating a configuration of an electronic blackboard system according to a first embodiment and a second embodiment of the present invention;

FIG. 2 is a configuration diagram illustrating a hardware configuration of an electronic blackboard used for the electronic blackboard system according to the first embodiment of the present invention;

FIG. 3 is a functional block diagram of the electronic blackboard used for the electronic blackboard system;

FIG. 4 is a view illustrating a display screen on the electronic blackboard;

FIG. 5 is a view illustrating layers of the display screen on the electronic blackboard;

FIG. 6 is a functional block diagram of a communication terminal used for the electronic blackboard system;

FIG. 7 is a diagram illustrating a procedure for generating and distributing a distribution image in the electronic blackboard system;

FIG. 8 is a view illustrating a display screen on a communication terminal according to a modification of the first embodiment;

FIG. 9 is a functional block diagram of an electronic blackboard used for the electronic blackboard system according to the second embodiment;

FIG. 10 is a view illustrating a display screen on the electronic blackboard according to the second embodiment;

FIG. 11 is a view illustrating a display screen on the electronic blackboard and display screens on communication terminals according to the second embodiment;

FIG. 12 is a view illustrating selection of a temporary distribution image in the electronic blackboard system;

FIG. 13 is a view illustrating display screens on an electronic blackboard and the communication terminals when the temporary distribution image is distributed in the electronic blackboard system;

FIG. 14 is a diagram illustrating a procedure for distributing the temporary distribution image in the electronic blackboard system; and

FIG. 15 is a flowchart illustrating a procedure in which a frame output unit of the electronic blackboard acquires a distribution image.

The accompanying drawings are intended to depict exemplary embodiments of the present invention and should not be interpreted to limit the scope thereof. Identical or similar reference numerals designate identical or similar components throughout the various drawings.

### DETAILED DESCRIPTION OF THE PREFERRED EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment has an object to generate a distribution image with a specific image undesirable for distribution being excluded, enabling easy and suitable viewing at a communication terminal.

The following describes in detail the present invention by way of embodiments illustrated in the drawings. The present invention includes the following configurations for easily and suitably distributing a desired image to a communication terminal, with a specific image undesirable for distribution being excluded. In the embodiments below, a display apparatus is exemplified by an electronic blackboard, and a display system is exemplified by an electronic blackboard system in which the electronic blackboard and communication terminals are connected via a communication network.

### First Embodiment

First, the following describes an electronic blackboard according to a first embodiment of the present invention.

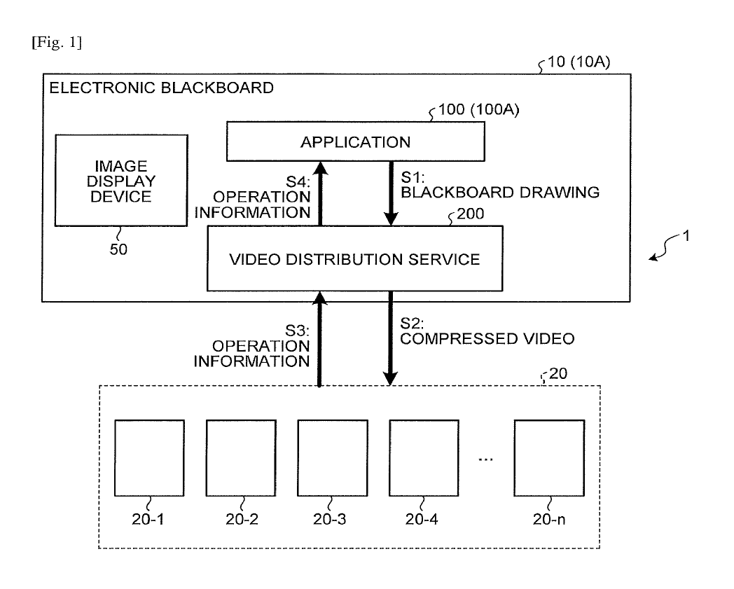

FIG. 1 is a block diagram illustrating a configuration of an electronic blackboard system according to the first embodiment of the present invention. An electronic blackboard system 1 according to the present embodiment includes an electronic blackboard 10 and a plurality of communication terminals 20 (20-1, 20-2, . . . , 20-n) connected to the electronic blackboard 10 via a wireless local area network (LAN). The wireless LAN is used for an intra-company network, for example. The electronic blackboard 10 can be connected to the communication terminals 20 via various wired or wireless communication networks such as a wired LAN and the Internet, not limited to the wireless LAN.

The electronic blackboard 10 includes an application 100, a video distribution service 200, and an image display device 50.

The communication terminals 20 are notebook-type personal computers, tablet computers, and other devices, and operate on various operating systems (OSs) such as iOS, Android (registered trademark), Windows (registered trademark), and Mac OS (registered trademark). The communication terminals 20 each include an image display unit.

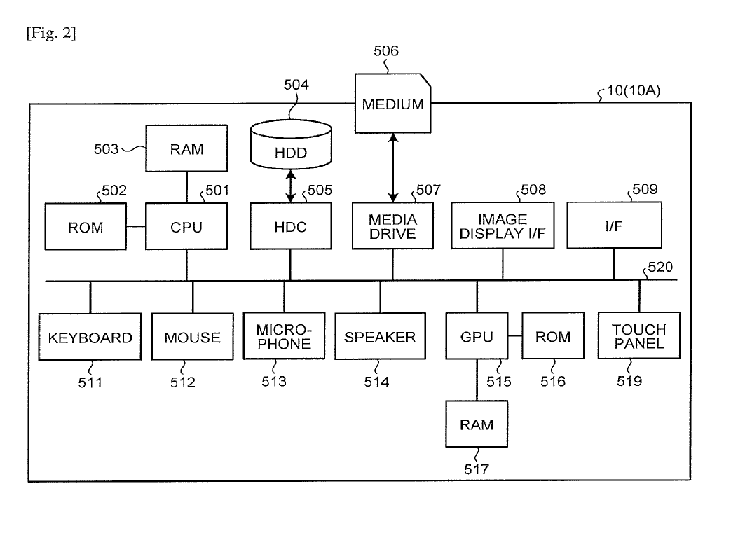

FIG. 2 is a configuration diagram illustrating a hardware configuration of the electronic blackboard used for the electronic blackboard system according to the first embodiment of the present invention.

The electronic blackboard 10 includes a central processing unit (CPU) 501, a read only memory (ROM) 502, a random access memory (RAM) 503, a hard disc drive (HDD) 504, a hard disk controller (HDC) 505, a media drive 507, an image display interface (I/F) device 508, an interface (I/F) 509, a keyboard 511, a mouse 512, a microphone 513, a speaker 514, a graphics processing unit (GPU) 515, and a touch panel 519, which are connected via an extension bus line 520.

The CPU 501 controls the entire operation of the electronic blackboard 10. The ROM 502 stores therein a computer program, such as an initial program loader (IPL), used for driving the CPU 501. The RAM 503 is used as a work area for the CPU 501. The HDD 504 stores therein various pieces of data such as a computer program. The HDC 505 controls reading and writing of various pieces of data from and to the HDD 504 under the control of the CPU 501. The media drive 507 controls reading and writing (storing) of data from and to a recording medium 506 such as a flash memory. The image display interface 508 is used for connecting to the image display device 50 that displays various pieces of information. The I/F 509 is used for transmitting data via a communication network or for connecting a dongle. The GPU 515 is connected to a ROM 516 storing therein a computer program used for driving the GPU 515, and a RAM 517 used as a work area for the GPU 515. The extension bus line 520 includes an address bus, a data bus, and other lines for electrically connecting the components described above. The touch panel 519 detects coordinates of a position on the image display device 50 where an input pen or a finger touches.

In the electronic blackboard 10 having the above-described configuration, the CPU 501 executes predetermined image distribution software to implement the application 100 and the video distribution service 200 that distributes, as video, a plurality of images generated by the application 100.

The application 100 detects an operation event that is a stroke of writing with an input pen or a finger or a paging operation on the image display device 50 through the touch panel 519, and draws a stroke or the like on the image display device 50 based on the operation event detected through the touch panel 519. The application 100 then outputs an image to be distributed to the communication terminals 20 (distribution image) and an image to be displayed on the image display device 50 (display image), and distributes the distribution image to the video distribution service 200 (Step S1). The video distribution service 200 compresses a plurality of images resulted from the drawing by the application 100 and distributes the images to the communication terminals 20 (Step S2). In this example, the distribution is performed from one electronic blackboard 10 to a plurality of (n) communication terminals 20-1, 20-2, . . . , 20-n at the same time.

Each of the communication terminals 20 displays an image acquired from the electronic blackboard 10, on the display unit. The communication terminal 20 allows a touch operation or a mouse operation to be performed on the image displayed on the display unit to draw on video. Operation information of the touch operation or the mouse operation, for example, is transmitted to the video distribution service 200 of the electronic blackboard 10 (Step S3), and further transmitted from the video distribution service 200 to the application 100 (Step S4).

The following describes a functional configuration of the electronic blackboard 10 in the electronic blackboard system 1.

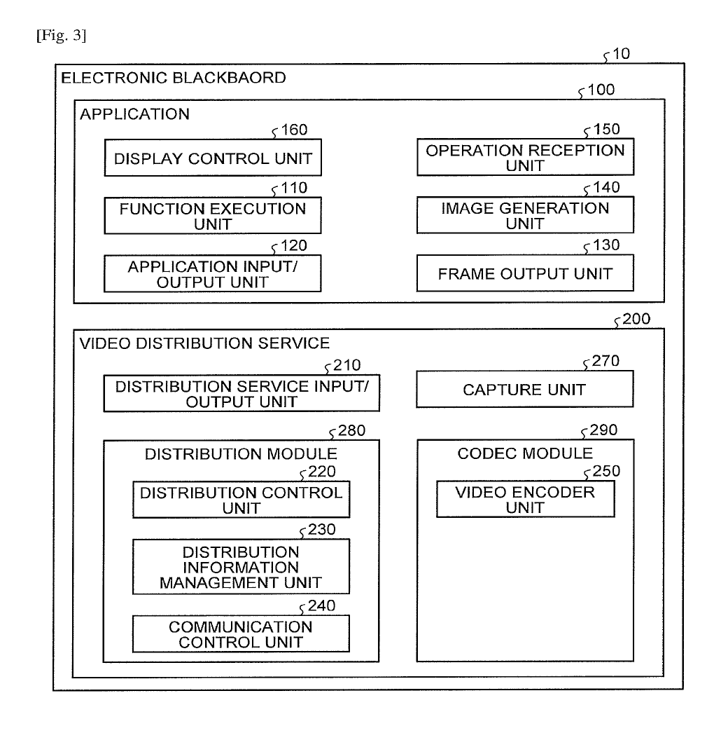

FIG. 3 is a functional block diagram of the electronic blackboard used for the electronic blackboard system. The electronic blackboard 10 includes the application 100 and the video distribution service 200.

The application 100 provides a user with a function in cooperation with the video distribution service 200. The application 100 includes: a function execution unit 110; an application input/output unit 120; a frame output unit 130; an image generation unit 140 serving as an image generating unit; an operation reception unit 150; and a display control unit 160.

The function execution unit 110 is a module that executes a function specific to the electronic blackboard. The application input/output unit 120 receives data, for example, an operation event, output from a distribution service input/output unit 210. The function execution unit 110 converts the received data into a format that the function execution unit 110 can process, and distributes the converted data. The function execution unit 110 transmits data regarding service start, service stop, and the like to the distribution service input/output unit 210.

The frame output unit 130 outputs images to be distributed as video to the communication terminals 20. For example, the frame output unit 130 outputs RGB bitmap images as video compressed in H.264/AVC format.

The image generation unit 140 generates a display image to be displayed on the image display device 50 and a distribution image to be distributed to the communication terminals 20.

The operation reception unit 150 receives an operation such as writing based on the coordinates of the input pen or the finger detected through the touch panel 519.

The display control unit 160 causes the image display device 50 to display the display image generated by the image generation unit 140. Thus, the image display device 50 displays an image of an operation panel and an image of the electronic blackboard in a superimposed manner.

An image generated as the distribution image by the image generation unit 140 is output to the frame output unit 130. The image output by the frame output unit 130 to the video distribution service 200 is captured by a capture unit 270 and distributed to the communication terminals 20.

When an operation is received from one of the communication terminals 20, operation information from the communication terminal 20 is input to the application input/output unit 120 through the distribution service input/output unit 210 of the video distribution service 200, transferred to the function execution unit 110, and processed in the same manner as described above.

The video distribution service 200 is a general term for modules of the electronic blackboard 10 in the electronic blackboard system 1. The video distribution service 200 includes, as illustrated in FIG. 3, the distribution service input/output unit 210, a distribution control unit 220, a distribution information management unit 230, a communication control unit 240, and a video encoder unit 250. The distribution control unit 220, the distribution information management unit 230, and the communication control unit 240 constitute a distribution module 280, and the video encoder unit 250 constitutes a codec module 290.

The distribution service input/output unit 210 receives data (for example, data regarding service start and service stop) output from the application input/output unit 120. The distribution service input/output unit 210 transmits data such as an operation event to the application input/output unit 120. The distribution information management unit 230 manages a video encode setting related to image distribution, and information on the communication terminals 20 that are being connected. The communication control unit 240 serving as a communicating unit performs overall control of the image distribution and issues instructions to start and end the codec module 290.

The video encoder unit 250 acquires and compresses an image from the capture unit 270 to generate compressed data. The capture unit 270 acquires a frame image output from the frame output unit 130 of the application 100.

The following describes the display image and the distribution image generated by the image generation unit 140.

FIG. 4 is a view illustrating a display screen on the electronic blackboard. The image display device 50 of the electronic blackboard 10 displays, other than an acquired image or a handwritten image 60, an operation panel 70 at the side of the image. The handwritten image 60 includes a stroke image 61 and text 62 being “Whiteboard Application” that have been drawn. The operation panel 70 includes a plurality of icons. When the operation reception unit 150 detects selection of a pen icon 71 with an input pen, the function execution unit 110 changes colors used for writing.

In this configuration, when an image including the handwritten image 60 and the operation panel 70 is distributed to and displayed on each communication terminal 20, a user of the communication terminal 20 misunderstands that the user can operate the handwritten image 60 with the displayed operation panel 70.

In the present embodiment, the electronic blackboard 10 generates an image with the operation panel 70 being excluded, and distributes only the handwritten image 60 to the communication terminals 20. Not only the operation panel 70 but also a thumbnail or other item displayed on the lower part of the image display device 50 can be a target of exclusion. The target of exclusion can be defined by the specification or other setting of the communication terminals 20.

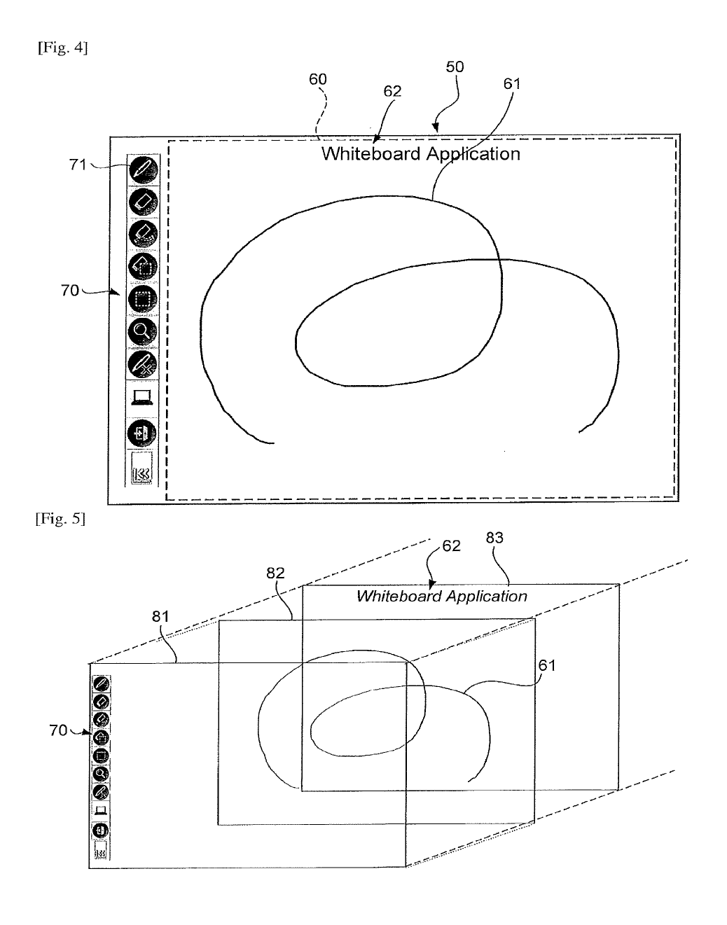

FIG. 5 is a view illustrating layers of the display screen on the electronic blackboard.

As illustrated in FIG. 5, the operation panel 70 is displayed on an operation panel display layer 81, the stroke image 61 on a handwritten image layer 82, and the text 62 on a handwritten image layer 83. Not limited to the two handwritten image layers, a desired handwritten image layer may be selected and superimposed. The operation panel 70 displayed on the image display device 50 is a specific image, and the operation panel display layer 81 is a specific layer. The stroke image 61 and the text 62 are images other than the specific image. The handwritten image layers 82 and 83 are other layers.

The display image is generated from the operation panel display layer 81 and the handwritten image layers 82 and 83 superimposed by the image generation unit 140. The distribution image is generated from the handwritten image layers 82 and 83 superimposed by the image generation unit 140. In other words, the distribution image is an image obtained by excluding the operation panel display layer 81 from the display image.

When a plurality of handwritten image layers are present, the image generation unit 140 can superimpose a specified desired handwritten image layer to generate an image.

Each layer may be assigned with metadata or an ID that identifies the layer, so that whether the layer is to be included in a distribution image can be determined.

The following describes the communication terminals 20.

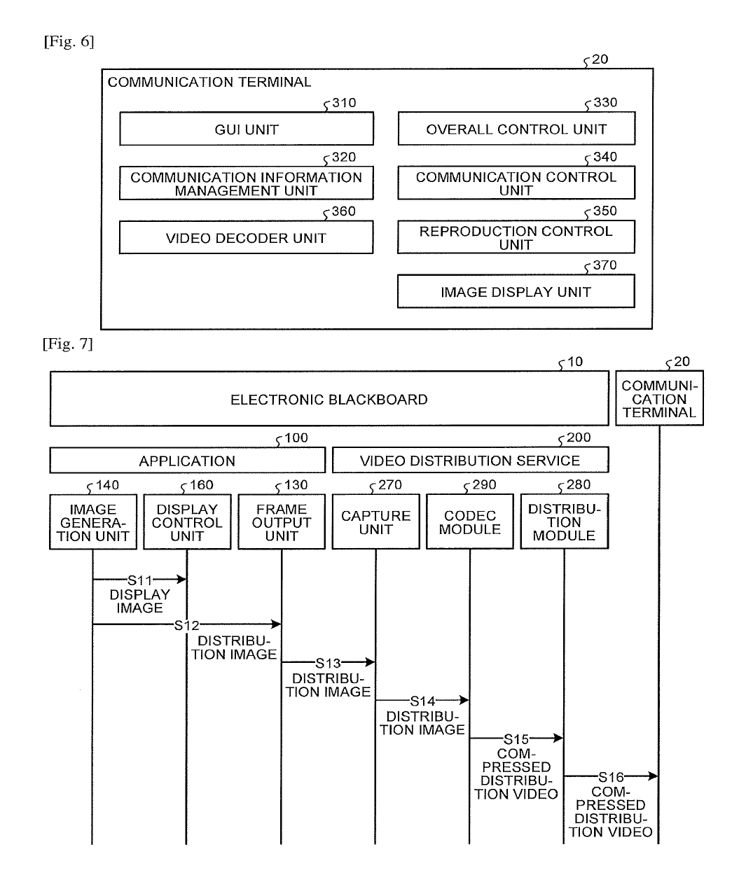

FIG. 6 is a functional block diagram of an electronic processing terminal used for an image processing system. The communication terminals 20 each include a graphical user interface (GUI) unit 310, a communication information management unit 320, an overall control unit 330, a communication control unit 340, a reproduction control unit 350, a video decoder unit 360, and an image display unit 370.

The GUI unit 310 causes the image display unit 370 of the communication terminal 20 to display a user interface (UI). The overall control unit 330 performs overall control such as issuing instructions to start and disconnect communication. The communication information management unit 320 holds information on distribution, for example, a video encode setting. The communication control unit 340 controls communication with the electronic blackboard 10, and transmits and receives data to and from the video distribution service 200 of the electronic blackboard 10. The reproduction control unit 350 inputs compressed data to the video decoder unit 360. The video decoder unit 360 decodes the compressed data and causes the image display unit 370 to display an image. The image display unit 370 includes a liquid-crystal image display panel and displays a GUI based on an image output from the GUI unit 310 and a distribution image based on the image from the video decoder unit 360.

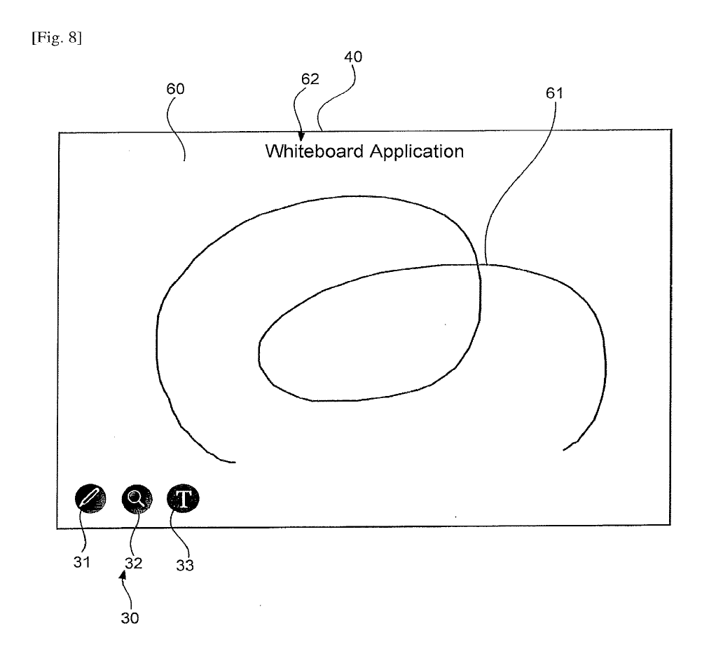

The following describes a flow of processing performed in the electronic blackboard system 1. FIG. 7 is a diagram illustrating a procedure for generating and distributing a distribution image in the electronic blackboard system.

The image generation unit 140 of the application 100 superimposes all layers including the operation panel display layer 81 to be displayed on the image display device 50 of the electronic blackboard 10, to generate a display image. The image generation unit 140 transmits the display image to the display control unit 160 (Step S11).

At the same time, the image generation unit 140 generates a distribution image that does not include the operation panel display layer 81 and outputs the distribution image to the frame output unit 130 (Step S12).

The capture unit 270 of the video distribution service 200 captures and acquires the image output to the frame output unit 130 (Step S13). The captured image is transmitted to the codec module 290 (Step S14). In the codec module 290, the video encoder unit 250 compresses the image to generate compressed data and transmits the compressed data to the distribution module 280 (Step S15).

The distribution module 280 transmits the compressed data to the communication terminals 20 (Step S16). In each of the communication terminals 20, the video decoder unit 360 decodes the compressed data and the GUI unit 310 displays the distribution image with the operation panel being excluded.

By the above-described processing, the communication terminals 20 each displays the distribution image including the handwritten image layers 82 and 83, with the operation panel display layer 81 being excluded.

The distribution image may be formed with desired layers selected from a plurality of handwritten image layers such as the layers 82 and 83, and distributed.

In this manner, the operation panel is excluded from the distribution image distributed to each communication terminal 20 in order to prevent a user of the communication terminal 20 from misunderstanding that the user can operate the blackboard from the operation panel.

The following describes a modification of the first embodiment.

FIG. 8 is a view illustrating a display screen on a communication terminal in the electronic blackboard system according to the modification of the first embodiment.

If each communication terminal 20 allows only viewing, the image display unit 370 of the communication terminal 20 may display only a handwritten image without an operation panel. However, some communication terminals desirably provide a number of functions such as changing colors of handwriting and enlarging display.

Thus, in the present modification, the communication terminals 20 can each display a unique operation panel 30. For example, the operation panel 30 may include a pen writing icon 31, an enlarged-display icon 32, and a text input icon 33.

As described above, displaying the unique operation panel 30 on each of the communication terminals 20 enables provision of an appropriate operation panel depending on the type of the communication terminal 20. For example, when one of the communication terminals 20 includes a keyboard, the text input icon 33 may be specified so as to facilitate text input to the display unit.

### Second Embodiment

The following describes an electronic blackboard system according to a second embodiment of the present invention.

An electronic blackboard system 1A according to the second embodiment includes, as illustrated in FIG. 1, an electronic blackboard 10A and the communication terminals 20.

In the electronic blackboard system 1A according to the present embodiment, the electronic blackboard 10A can select, as an image to be transmitted to the communication terminals 20, a predetermined image other than a handwritten image according to an external instruction such as an instruction from an operator of the electronic blackboard 10A. The predetermined image is distributed as a distribution image to the communication terminals 20.

As illustrated in FIG. 1, the electronic blackboard system 1A includes the electronic blackboard 10A and the communication terminals 20 (20-1, 20-2, . . . , 20-n) connected to the electronic blackboard 10A via a wireless LAN. The wireless LAN is used for an in-house network, for example.

The electronic blackboard 10A includes an application 100A, the video distribution service 200, and the image display device 50. The communication terminals 20 are the same as the first embodiment. The electronic blackboard 10A has the same hardware configuration as the electronic blackboard 10 according to the first embodiment, which is illustrated in FIG. 2.

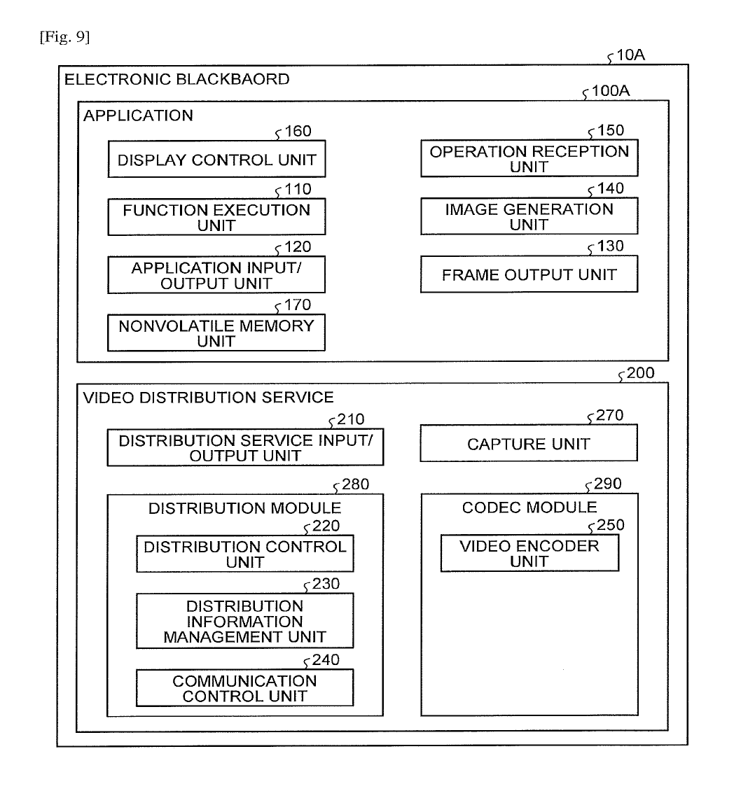

FIG. 9 is a functional block diagram of the electronic blackboard used for the electronic blackboard system according to the second embodiment. The electronic blackboard 10A includes the application 100A and the video distribution service 200.

The application 100A has the same configuration as the application 100 of the first embodiment except that the application 100A includes a nonvolatile memory unit 170 serving as an image storing unit. That is, the application 100A includes, other than the nonvolatile memory unit 170, the function execution unit 110, the application input/output unit 120, the frame output unit 130, the image generation unit 140, the operation reception unit 150, and the display control unit 160. The nonvolatile memory unit 170 preliminarily stores therein one or more distribution layers selectable as other layers.

The communication terminals 20 used in the electronic blackboard system 1A each have the same configuration as the communication terminals 20 used in the electronic blackboard system 1 according to the first embodiment (refer to FIG. 6).

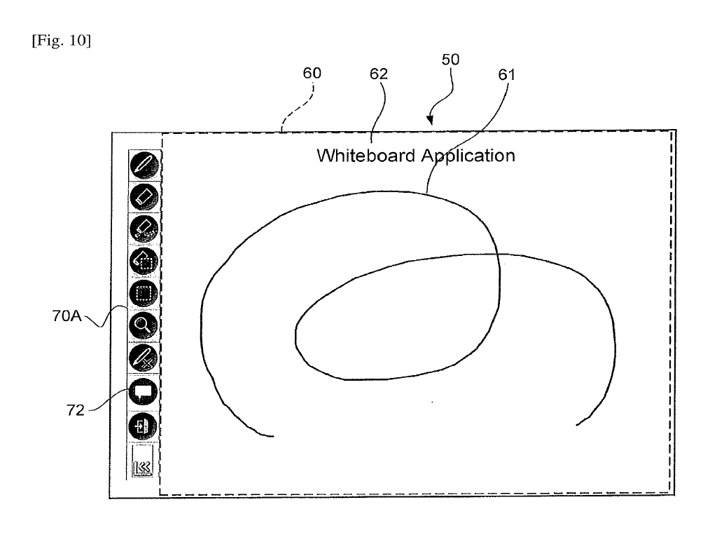

FIG. 10 is a view illustrating a display screen on the electronic blackboard according to the second embodiment. The image display device 50 in the electronic blackboard system 1A displays an operation panel 70A and the handwritten image 60 including the stroke image 61 and the text 62, for example. The configuration of the handwritten image 60 is the same as the configuration of the handwritten image 60 in the first embodiment.

The operation panel 70A includes a plurality of function icons. In the present embodiment, the operation panel 70A includes a message distribution icon 72 for distributing, as a distribution image, a layer specified from one or more distribution layers displaying respective messages stored in the nonvolatile memory unit 170.

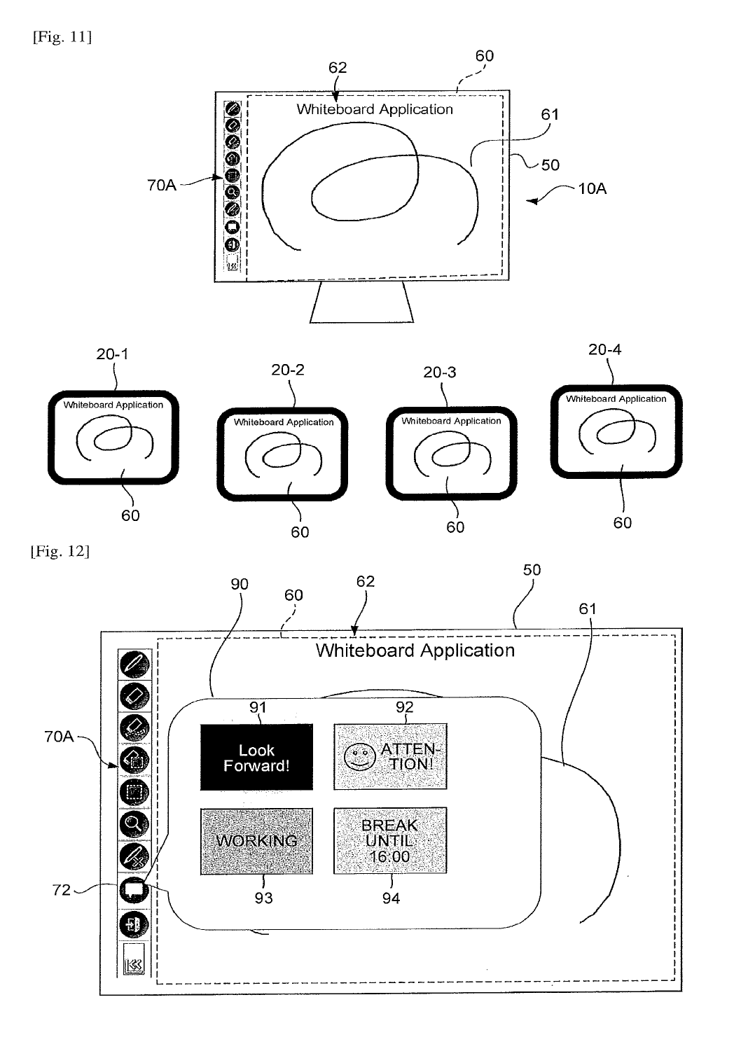

FIG. 11 is a view illustrating a display screen on the electronic blackboard and display screens on the communication terminals according to the second embodiment. In FIG. 11, the image display device 50 of the electronic blackboard 10A displays the handwritten image 60 and the operation panel 70A. The handwritten image 60 is distributed as the distribution image to the communication terminals 20 (20-1 to 20-4) and displayed on the respective image display units. This state is the same as the display in the first embodiment. The procedure for distributing the handwritten image 60 is the same as the first embodiment, which is illustrated in FIG. 7.

The following describes the distribution of an image stored as a distribution image in the nonvolatile memory unit 170 to the communication terminals 20.

It is assumed that the electronic blackboard system 1A is used in an educational field. A teacher performs writing or presents material on the electronic blackboard 10A to give explanation. Students use the communication terminals 20 such as tablet terminals. Each student views an image of the electronic blackboard on the screen of the student's communication terminal 20, and inputs handwritten information from the communication terminal 20 as needed.

Each student can view the handwritten image 60 on the screen of the communication terminal 20 and thus the student's attention is on the communication terminal 20. When the teacher needs the students to look up and give attention to the teacher, it is desirable that a desired message or image be displayed on each communication terminal 20 without changing the image that has been displayed on the image display device 50 of the electronic blackboard 10A.

In the present embodiment, specifying the message distribution icon 72 on the operation panel 70A of the electronic blackboard 10A enables selection of a necessary image from images stored in the nonvolatile memory unit 170 and transmission of the image to the communication terminals 20.

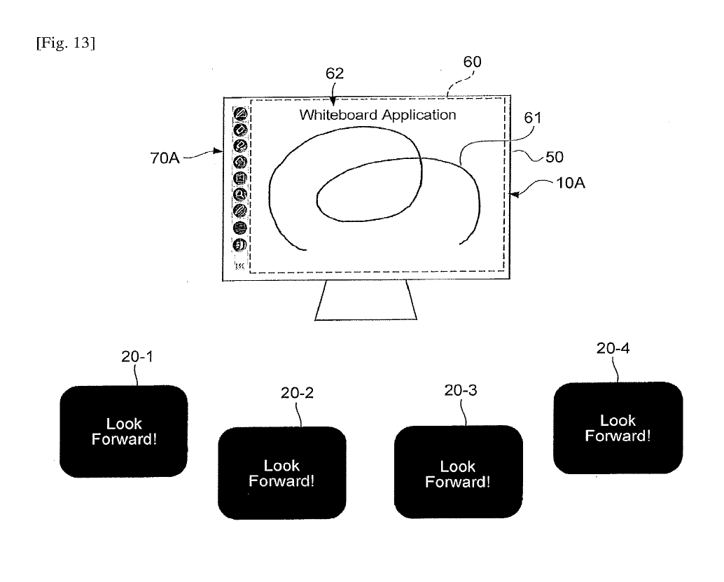

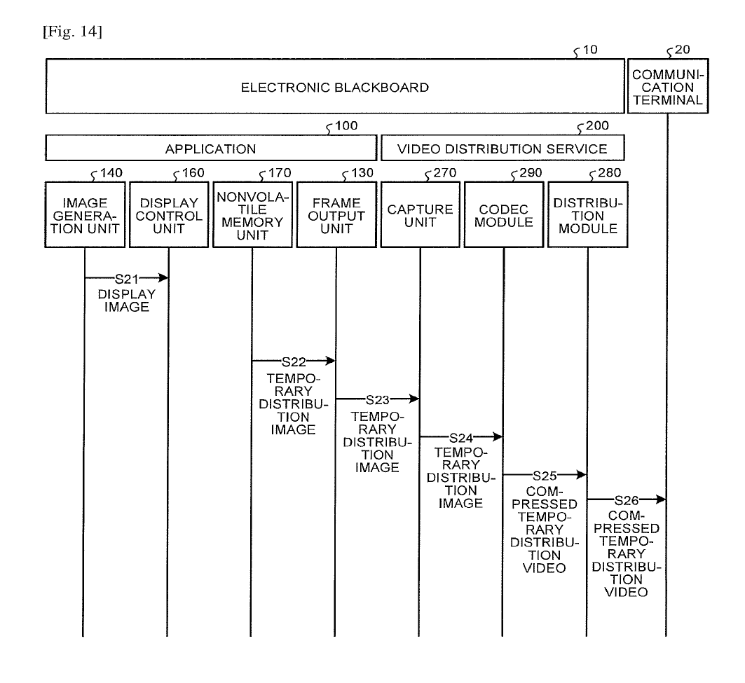

FIG. 12 is a view illustrating selection of a temporary distribution image in the electronic blackboard system. FIG. 13 is a view illustrating display screens on the electronic blackboard and the communication terminals when the temporary distribution image is distributed in the electronic blackboard system.

These diagrams illustrate an example screen displayed on the communication terminals 20. Selecting the message distribution icon 72 displays a list 90 of the temporary distribution images that can be distributed to the communication terminals 20, as illustrated in FIG. 12.

In this example, four images are selectably displayed, which are an image 91 indicating “Look Forward!”, an image 92 indicating “Attention!”, an image 93 indicating “Working”, and an image 94 indicating “Break until 16:00”. One of the four temporary distribution images is selected. These temporary distribution images are stored as temporary distribution layers in the nonvolatile memory unit 170. From the temporary distribution layers, a layer is selected by the function execution unit 110 serving as a selecting unit, formed as a distribution image by the image generation unit 140, and distributed to the communication terminals 20.

When the temporary distribution image is distributed, all the communication terminals 20 (20-1 to 20-4) display the selected temporary distribution image (in this example, the image 91 of “Look Forward!”) in place of the handwritten image 60, as illustrated in FIG. 13. The nonvolatile memory unit 170 is set to be capable of storing therein a temporary image freely added from the electronic blackboard.

Displaying such temporary distribution image can bring the students' attention to the electronic blackboard 10A instead of the respective communication terminals 20. Under this state, which is regarded as the state of distributing the temporary distribution image, operation from the communication terminals can be prohibited. Reselecting the message icon on the operation panel 70A on the electronic blackboard 10A ends the state of distributing the temporary distribution image, and redistributes the handwritten image 60 to the communication terminals 20.

The following describes a procedure for distributing the temporary distribution image.

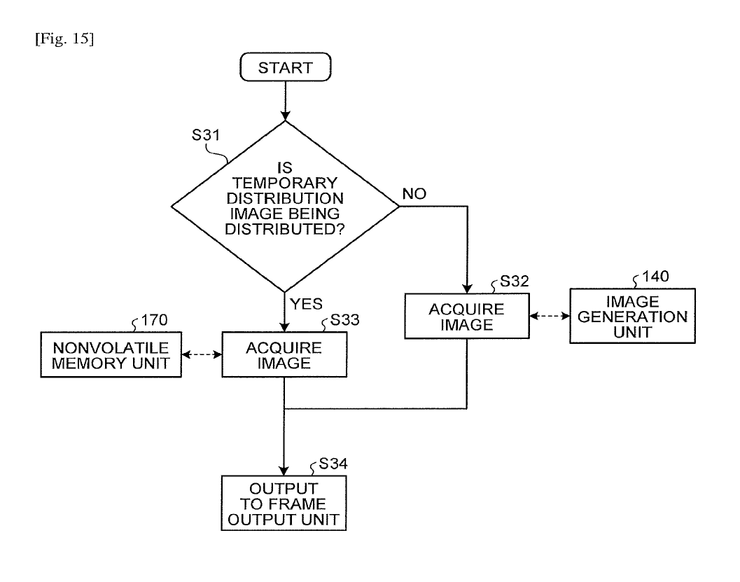

FIG. 14 is a diagram illustrating a procedure for distributing the temporary distribution image in the electronic blackboard system. The image generation unit 140 of the application 100A generates a display image to be displayed on the image display device 50 of the electronic blackboard 10A, and transmits the display image to the display control unit 160 (Step S21). The frame output unit 130 acquires a temporary distribution image selected from the nonvolatile memory unit 170 (Step S22). The distribution information management unit 230 then transmits the temporary distribution image to the capture unit 270 (Step S23). The capture unit 270 transmits the temporary distribution image to the codec module 290 (Step S24). The codec module 290 compresses the temporary distribution image and transmits the compressed temporary data to the distribution module 280 (Step S25). The distribution module 280 distributes the compressed temporary data to the communication terminals 20 (Step S26). In the video distribution service 200, the video decoder unit 360 decodes the compressed temporary data and the image display unit 370 displays a temporary display image.

The following describes a procedure in which the frame output unit 130 of the electronic blackboard 10A acquires a distribution image and a temporary distribution image. FIG. 15 is a flowchart illustrating a procedure in which the frame output unit of the electronic blackboard acquires a distribution image.

The frame output unit 130 determines whether a temporary distribution image is being distributed (Step S31). In a normal state of distributing no temporary distribution image (No at Step S31), the handwritten image 60 is acquired as a distribution image from the image generation unit 140 (Step S32) and transmitted to the frame output unit 130 (step S34).

If a temporary distribution image is being distributed (Yes at Step S31), the temporary distribution image selected from the nonvolatile memory unit 170 is acquired (Step S33).

As described above, the electronic blackboard system 1A according to the second embodiment can distribute a temporary distribution image to the communication terminals 20 as needed.

Each of the electronic blackboards 10 and 10A may include a web server unit. This configuration enables each communication terminal 20 to use a web browser to view an image from the frame output unit 130.

### Configurations, Actions, and Effects of Aspects of Present Invention

### First Aspect

The electronic blackboard 10 of the present aspect generates an image viewable by the communication terminal 20 and includes the image generation unit 140. The image generation unit 140 generates a display image in which the operation panel display layer 81 for displaying the operation panel 70 and the handwritten image layers 82 and 83 for displaying respective images other than the operation panel 70are overlapped, and a distribution image in which the operation panel display layer 81 is excluded and only the other layers are overlapped.

According to the present aspect, the image generation unit 140 generates the display image generated from the operation panel display layer 81 and the handwritten image layers 82 and 83, and the distribution image generated from the handwritten image layers 82 and 83. Thus, the distribution image is generated with a specific image undesirable for distribution being excluded, enabling easy and suitable viewing at the communication terminal 20.

### Second Aspect

In the present aspect, the image generation unit 140 of the electronic blackboard 10 superimposes a desired layer among the the handwritten image layers 82 and 83, to form the distribution image.

According to the present aspect, the image generation unit 140 generates the display image from the operation panel display layer 81 and the handwritten image layers 82 and 83. Thus, the distribution image is generated with a specific image undesirable for distribution being excluded, enabling easy and suitable viewing at the communication terminal 20.

### Third Aspect

The present aspect includes: the nonvolatile memory unit 170 that preliminarily stores therein one or more temporary distribution layers selectable as the other layers, and a selecting unit that selects, as the other layers, any one of the one or more distribution layers stored in the nonvolatile memory unit 170, according to an instruction from the message distribution icon 72 on the operation panel 70A.

According to the present aspect, the image generation unit 140 selects, according to an external instruction, a layer from the temporary distribution layers stored in the nonvolatile memory unit 170, to form the distribution image. Thus, the electronic blackboard 10A can distribute a temporary distribution image to the communication terminal 20 at a desired timing.

### Fourth Aspect

In the present aspect, the electronic blackboard 10 or 10A includes the video distribution service 200 that distributes the distribution image to the communication terminal 20.

According to the present aspect, the video distribution service 200 can distribute the distribution image from the electronic blackboard 10 or 10A to the communication terminal 20. Thus, the communication terminal 20 can display the distribution image from the electronic blackboard 10 or 10A.

### Fifth Aspect

In the present aspect, the electronic blackboard 10 includes the web server unit that publishes the distribution image.

According to the present aspect, the communication terminal 20 can acquire the distribution image from the electronic blackboard 10 through the web server unit using a web browser. Thus, the communication terminal 20 can easily display the distribution image.

### Sixth Aspect

In the present aspect, the electronic blackboard 10A includes a registering unit that registers an image as the one or more distribution layers, in the nonvolatile memory unit 170.

According to the present aspect, the electronic blackboard 10A can register an image in the nonvolatile memory unit 170. Thus, various images can be distributed as a temporary distribution image to the communication terminal 20.

### Seventh Aspect

In the present aspect, the electronic blackboard system 1 or 1A includes: the electronic blackboard 10 or 10A; and the communication terminal 20 that is connected to the electronic blackboard 10 or 10A via a network, and receives and displays the distribution image.

According to the present aspect, the electronic blackboard 10 or 10A distributes, to the communication terminal 20, the display image generated from the operation panel display layer 81 and the handwritten image layers 82 and 83, and the distribution image generated from the handwritten image layers 82 and 83, the display image and the distribution image being generated by the image generation unit 140. Thus, the distribution image is generated with the image of the operation panel 70 undesirable for distribution being excluded, enabling easy and suitable viewing at the communication terminal 20.

According to an embodiment, the distribution image is generated with a specific image undesirable for distribution being excluded, enabling easy and suitable viewing at the communication terminal.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

### REFERENCE SIGNS LIST

1, 1A Electronic blackboard system
10, 10A Electronic blackboard
20 Communication terminal
100, 100A Application
110 Function execution unit
120 Application input/output unit
130 Frame output unit
140 Image generation unit
150 Operation reception unit
160 Display control unit
170 Nonvolatile memory unit
200 Video distribution service

What is claimed is:

1. An electronic blackboard system comprising:
an electronic blackboard; and
at least one communication terminal connected to the electronic blackboard via a communication network,
the electronic blackboard comprising:
an image generation unit configured to superimpose layers to be displayed in the electric black board, to generate a display image, and generate a distribution image that does not include an operation panel display layer for displaying an operation panel; and
a distribution module configured to transmit the distribution image to the at least one communication terminal,
each of the at least one communication terminal comprising:
a communication control unit configured to receive the distribution image transmitted from the electronic blackboard; and
an image display unit configured to display the distribution image that is received by the communication control unit and in which the operation panel display layer is excluded.

2. The electronic blackboard system according to claim 1, wherein the layers to be displayed in the electronic blackboard include:
the operation panel display layer for displaying the operation panel; and
an handwritten image layer for displaying a stroke image and a text.

3. An electronic blackboard system comprising:
an electronic blackboard; and
at least one communication terminal connected to the electronic blackboard via a communication network,
the electronic blackboard comprising:
an image generation unit configured to superimpose layers to be displayed in the electric black board, to generate a display image, and generate a distribution image that does not include an operation panel display layer for displaying an operation panel;
a video encoder unit configured to compresses the distribution image to generate compressed data; and
a distribution module configured to transmit the compressed data generated by the video encoder unit to the at least one communication terminal,
each of the at least one communication terminal comprising:
a communication control unit configured to receive the compressed data transmitted from the electronic blackboard;
a video decoder unit configured to generate the distribution image from the compressed data transmitted from the electronic blackboard; and
an image display unit configured to display the distribution image that is generated by the video decoder unit and in which the operation panel display layer is excluded.
